(19) United States
(12) Patent Application Publication
(10) Pub. No.: US 2011/0008264 A1
(43) Pub. Date: Jan. 13, 2011

(54) METHOD FOR REPELLING A RODENT, METHOD FOR CAPTURING A RODENT AND RODENT REPELLENT

(75) Inventors: Tsutomu Negishi, Tokyo (JP); Tomihiro Kobori, Hyogo (JP); Kei Ishii, Hyogo (JP); Masanaga Yamaguchi, Hyogo (JP)

Correspondence Address: SUGHRUE-265550, 2100 PENNSYLVANIA AVE. NW, WASHINGTON, DC, 20037-3213, US

(73) Assignee: Earth Chemical Co., Ltd., Tokyo (JP)

(21) Appl. No.: 12/521,332

(22) PCT Filed: Dec. 17, 2007
(86) PCT No.: PCT/JP2007/074253

§ 371 Date: Jun. 26, 2009

(30) Foreign Application Priority Data
Dec. 27, 2006 (JP) 2006-351454
Dec. 28, 2006 (JP) 2006-355015
Jul. 18, 2007 (JP) 2007-186738
Jul. 19, 2007 (JP) 2007-188280

(51) Int. Cl. A01N 33/26; A01N 65/22; A01P 11/00; A01M 23/00

(52) U.S. Cl. 424/40; 424/745; 43/1

(57) ABSTRACT

A rodent repelling method which uses smoke.

The rodent repelling method of the invention is a method for repelling a rodent, which uses a smoke generated by thermal decomposition of azodicarbonamide as an active ingredient and the aforementioned smoke is diffused to a smoke quantity of 45 cpm or more.

### TECHNICAL FIELD

This invention relates to a method for repelling rodents, a method for capturing rodents and a rodent repellent.

### BACKGROUND ART

Rodents are exerting bad influences upon humans and animals by forcing their way into houses, stores, warehouses and the like or inhabiting the same. Thus, arrangement of a rodent trap, application of a rodent poison and the countermeasures have been taken, but having a problem of requiring treatment of the captured or dead rodents.

In addition, prevention of the intrusion of rodents using a rodent repellent has also been carried out, and for example, a rodent repellent which uses monoterpenes (cf., Patent Reference 1), a rodent repellent which uses terpinene, terpineol or p-cymene (cf., Patent Reference 2) and the like are known.

By the way, when the active ingredient of a rodent repellent is spread from the arrange site, the repellent space becomes wide which is desirable. However, in the Patent References 1 and 2, the aforementioned respective components are mixed with a feed material and only a test on its feeding ratio is carried out, their repellent effect in the space is not disclosed so that their effects are not clear.

In this connection, various substances are conventionally known as the putting type rodent repellent, and those which use monoterpenes (Patent Reference 1), those which use lemongrass oil, lavender oil, orange oil, citronellol, geraniol and the like (Patent Reference 3), those which use terpinene, terpineol and p-cymene (Patent Reference 2) and the like can be exemplified.

However, the putting type rodent repellents disclosed in Patent References 1 to 3 are based on the repellent of rodents by vaporizing an odor, but their repellent range is narrow and their effects insufficient for rodents having strong warning nature and high learning ability.

Also, conventionally, damages caused by rodents which gnaw food, wall materials, electric cables and the like have been causing problems, and various rodent poisons and repellents have been examined for the purpose of preventing them. However, the desired effect can be obtained only at the site where the rodent poison or repellent is applied, so that it is difficult to repel rodents from the interior of a room, warehouse, under the floor and the like wide spaces.

In addition, repellent of animals and vermin by smoke has been examined conventionally. For example, repellent of birds by igniting a molded product consisting of wood flour, starch and the like and thereby generating smoke (cf., Patent Reference 4), capture and extermination of vermin with an arranged adhesive material by driving them out through the smoking of habitat of the vermin (cf., Patent Reference 5) and the like are known.

However, birds and vermin are different from rodents in terms of their habits, behavior and also reactions for stimuli and the like, and the aforementioned references do not describe on their application to rodents.

In addition, method for repelling rodents making use of smoke has not been examined, and only a member impregnated with tar or the like having a smell of a smoke component is known (cf., Patent Reference 6).

On the other hand, Patent Reference 7 discloses a rodent-repulsing device which comprises an infrared sensor for detecting invasion of rodents, an oscillator which oscillate a frequency of high frequency range is id abhorred rodents, a speaker which emits an ultrasonic wave of said frequency and a radiator which radiates light against invading rodents, characterized in that it is constituted in such a manner that it carries out emission of the ultrasonic wave from the speaker based on the detection signal by the infrared sensor and several times of radiation from the radiator, it is also constituted in such a manner that the detection signal by the infrared sensor is input to the oscillator via a tracking modulator and the frequency from the oscillator is modulated in response to the movement of rodents based on the fluctuation signal which is output from the tracking modulator, and an ozone generator which generates ozone gas based on the detection signal by the infrared sensor is arranged.

However, the rodent-repulsing device disclosed in Patent Reference 7 has problems in that it requires considerable cost for the system constitution because of the necessity of infrared sensor, frequency transmitter, ozone generator and the like and the rodent-repulsing effect is also insufficient.

Also, various rodent traps are known in addition to the aforementioned means, and there are adhesion types, wire netting types and the like. However, because of the habit of rodent as “strong warning nature”, trapping performance of the conventional traps was not always secure.

Patent Reference 8 discloses an adhesive trap which consists of an adhesive sheet in which an adhesive layer is applied to a base and a keeping member which keeps this adhesive sheet, for the purpose of capturing rodents and cockroaches.

However, rodents in houses and plants generally invade from a gaps of piping, a ventilation opening and an inspection opening and are present under the floor and the back of ceiling. When rodents presenting on the back of ceiling are captured using an adhesion type rodent trap, it is necessary to use from 30 to 40 adhesive sheets in a general house, and several thousand sheets in a factory, so that un-ignorable time and cost are required. In addition, since rodents have a strong warning nature as described in the foregoing, even when such a great number of adhesive materials are put down, rodents frequently take an action to avoid the adhesive materials, and thus posing a problem in that desired capturing effect cannot be obtained.

[Patent Reference 1] JP-A-3-181402

[Patent Reference 2] JP-A-4-288003

[Patent Reference 3] JP-A-2002-60308

[Patent Reference 4] JP-A-59-227808

[Patent Reference 5] JP-A-5-331014

[Patent Reference 6] JP-A-2006-174810

[Patent Reference 7] Japanese Utility Model Registration No. 3071411

[Patent Reference 8] JP-A-5-308879

### DISCLOSURE OF THE INVENTION

### Problems that the Invention is to Solve

An object of the invention is to provide a method for repelling rodents using smoke, which exerts strong repellent effect for rodents without using a repellent after all.

Another object of the invention is to provide a method for repelling rodents, which exerts excellent repellent effect for rodents having strong warning nature and high learning ability, has broad repellent range and can maintain the repellent period over a long period of time.

Still another object of the invention is to provide a method for capturing a rodent, which does not require time and cost and is excellent in rodent capturing ability.

A further object of the invention is to provide a rodent repellent, which has excellent rodent repellent effect in space.

### Means for Solving the Problems

The invention is as follows.

1. A method for repelling a rodent, which comprises a step of using a smoke generated by thermal decomposition of azodicarbonamide as an active ingredient and diffusing the aforementioned smoke to a smoke quantity of 45 cpm or more, or vaporizing a vaporization ingredient within a space where the rodent is present.

2. The method for repelling a rodent described in 1, wherein a smoke generated by thermal decomposition of azodicarbonamide is used as the active ingredient and the aforementioned smoke is diffused to a smoke quantity of 45 cpm or more and essential oils are also used as a rodent repellent.

3. A method for repelling a rodent, which comprises vaporizing a vaporization ingredient within a space where a rodent is present and using a rodent repellent containing at least one species of the rodent repellent ingredients within the aforementioned space.

4. A method for repelling a rodent, which comprises generating smoke by a smoke generator within a space where a rodent is present and using a rodent repellent containing at least one species of the rodent repellent ingredient within the aforementioned space.

5. A method for capturing a rodent, which comprises vaporizing a vaporization ingredient within a space where a rodent is present and capturing the rodent by a rodent trap arranged within the aforementioned space.

6. A method for capturing a rodent, which comprises generating smoke by a smoke generator within a space where a rodent is present and capturing the rodent by a rodent trap arranged within the aforementioned space.

7. A rodent repellent for use in the method for repelling a rodent described in 3 or 4, which comprises rosemary oil as the active ingredient.

### ADVANTAGE OF THE INVENTION

According to the invention, strong repellent effect for rodents can be exerted by only a small quantity of smoke without using a repellent after all.

The invention also comprises vaporization of a vaporization ingredient or generation of smoke by a smoke generator within a space where a rodent is present. According to this, a movement inducing effect and/or an repellent effect of rodents can be obtained within all of said space, so that a conventional problem is firstly solved. Also, returning of rodents to the aforementioned space can be prevented by the use of a rodent repellent containing at least one species of the aforementioned rodent repellent ingredients.

Further according to the method of the invention, rodents can be easily captured using a trap, by getting rid of the warning nature of rodents through the disturbance of movement of rodents effected by the diffusion of the vaporization ingredient or generation of smoke by a smoke generator within a space where rodents are present. Also, since the method of the invention can be carried out by preparing only a vaporization device or a smoke generator and a rodent trap, it does not require time and cost. In addition, according to an embodiment in which an adhesion type rodent trap is arranged, an embodiment in which smoke contains a rodent repellent ingredient, an embodiment in which a rodent trap is arranged in an air convection region in the aforementioned space and an embodiment in which a rodent trap is arranged in a dark region in the aforementioned space, the rodent capturing effect can be further improved.

Finally, the rosemary oil as the main component of the rodent repellent of the invention is not only excellent in its repellent effect but also its spread into space is good, so that it can add its excellent repellent effect not only to the vicinity of the arranged position but also to a broad space. In addition, since it also has an aromatic property, it can be used in a residential space without hindrance.

The following described the invention further in detail.

Firstly, (1) the method for repelling a rodent in which a smoke generated by the thermal decomposition of azodicarbonamide is used as an active ingredient and the aforementioned smoke is diffused to a smoke quantity of 45 cpm or more is described.

The rodent repellent method of this embodiment can repel rodents without using so-called repellent, by using a smoke generated by the thermal decomposition of azodicarbonamide as the active ingredient and diffusing the aforementioned smoke to a smoke quantity of 45 cpm or more, preferably 100 cpm or more, more preferably 200 cpm or more. Particularly it is desirable that the aforementioned smoke quantity is directly exposed to rodents. According to this, repellent (drive out) of rodents can be securely carried out.

As the azodicarbonamide, those which generate smoke by thermally decomposing at around 200° C. are desirable, and UnifoamAZ (manufactured by Otsuka Chemical Co., Ltd.), SELLMIC CE (manufactured by SANKYO Chemical Co., Ltd.) and the like can be exemplified.

The smoke quantity according to the invention means average dust quantity per minute (cpm) measured using a digital dust meter at a height of from 10 to 30 cm from the floor surface of a room, a warehouse, under the floor and the like, and illustratively, it can be measured by, for example, Digital Dust Indicator Model P-3 (manufactured by SHIBATA KAGAKU) or the like.

According to the invention, for example, two or more times of the measurement are carried out for 30 minutes from the generation of smoke at optional intervals and the average value is regarded as the smoke quantity.

According to the rodent repelling method (1) of the invention, 0.2 g or more, preferably from 1 to 30 g of azodicarbonamide, based on from 20 to 50 m³, may be used for generating a predetermined smoke quantity generated by its thermal decomposition.

Also, in the case of the device which uses a double layer container as shown the following FIG. 1 or the like, a small amount of smoke is generated by merely heating the container. Accordingly, as the smoke quantity of the smoke generated by thermally decomposing azodicarbonamide, the smoke quantities when azodicarbonamide is present in the container and when it is absent are respectively measured and the difference is regarded as the smoke quantity of the smoke generated by thermally decomposing azodicarbonamide.

Thermal decomposition of azodicarbonamide in the rodent repelling method (1) of the invention can be carried out, for example, by putting azodicarbonamide in the container of the smoke generating device shown in FIG. 1 and heating it by a heating means arranged on the outside of said container.

As the container, for example, a plastic container, a paper container, a metal container, a ceramic container, a glass container and the like can be cited. Also, as the heating means, for example, a hydroexothermic system which uses a reaction of calcium oxide, magnesium oxide, magnesium chloride, aluminum chloride, calcium chloride, iron chloride or the like hydroexothermic substance with water (cf. FIG. 1), an air oxidation heat generation system which uses metals that generate heat by the oxidation reaction of a mixture of iron carbide or iron powder and ammonium chlorate, a mixture of iron and potassium sulfate and the like, an electric hating system which uses a heater such as a heating element, a positive temperature coefficient thermistor, a semiconductor heater or the like, a platinum catalyst system, a piezo system, an ultrasonic atomization system and the like can be cited.

Though the rodent repelling method (1) of the invention can sufficiently exert the rodent repellent effect without repellent, the repellent effect can be improved as occasion demands by the joint use of various components having rodent repellent effect such as peppermint oil, a Japanese horseradish component (allyl isothiocyanate), shellflower extract, rosemary oil, terpineol, hexyl acetate, p-cymene, menthol, thymol, citronellal, various essential oils and the like. In addition, a perfume, a deodorant and the like can also be used jointly.

Next, (2) the method for repelling a rodent in which a vaporization ingredient is vaporized within a space where a rodent is present is described.

### (Vaporization Ingredient)

As the vaporization ingredient to be used in the rodent repelling method (2) of the invention, it is not particularly limited with the proviso that it is vaporized in the air and thereby can get rid of the warning nature of rodents by disturbing movement of rodents, but it is desirable to be vaporized by a vaporization device.

Though the vaporization ingredient to be used in the rodent repelling method (2) of the invention is not particularly limited, for example, those which have smells and are vaporized at room temperature among a Japanese horseradish component (allyl isothiocyanate), shellflower extract, monoterpenes, essential oil components such as peppermint oil, rosemary oil, lemongrass oil, lavender oil, orange oil and the like, azo compounds such as metoxadiazone, pyrazolone orange, azobenzene azobisisobutyronitrile, azo pigments and the like can be cited.

As the vaporization device, those which can vaporize vaporization ingredient at room temperature or under heating are desirable, and, for example, the vaporization device described in JP-A-11-127754 can be used. According to the invention, it is desirable to heat vaporization ingredients on a board heated, for example, to 200° C. to 500° C.

Next, the method for repelling a rodent, which comprises vaporizing a vaporization ingredient within a space where a rodent is present and using a rodent repellent containing at least one species of the aforementioned rodent repellent ingredients within the aforementioned space (to be referred to as the rodent repelling method (3) of the invention) and the method for repelling a rodent, which comprises generating smoke by a smoke generator within a space where a rodent is present and using a rodent repellent containing at least one species of the aforementioned rodent repellent ingredients within the aforementioned space (to be referred to as the rodent repelling method (4) of the invention) are described.

In the rodent repelling method (3) of the invention, the step for vaporizing a vaporization ingredient is the same as the aforementioned rodent repelling method (2).

### (Generation of Smoke)

According to the rodent repelling method (4) of the invention, it is desirable to generate smoke by a smoke generator within a space where a rodent is present. Though the smoke generator to be used in the invention is not particularly limited, for example, a device which uses a smoking agent, a device which uses a fumigant, a smoke candle and the like can be cited, and a fire cracker and the like which generate smoke and sound can also be used.

Such devices can be used by putting them on a habitat or activity area of rodents or, in the case of an attic, under the floor and the like narrow spaces, by supplying the smoke generated at a separate place through a pipe or the like.

In the rodent repelling method (4) of the invention, a rodent repellent ingredient is contained in the smoke. The smoke itself may have an evasive action, alternatively. As the rodent repellent ingredient, for example, a Japanese horseradish component (allyl isothiocyanate), shellflower extract, monoterpenes and essential oil components such as peppermint oil, rosemary oil, lemongrass oil, lavender oil, orange oil and the like can be cited.

According to rodent repelling method (4) of the invention, it is particularly desirable to introduce a smoke generated by the thermal decomposition of azodicarbonamide (to be referred to as AC smoke hereinafter) into a space where a rodent is present, together with the aforementioned rodent repellent ingredient. It is desirable to diffuse it into a space such that a smoke quantity inside the space becomes 45 cpm or more, preferably 100 cpm or more, more preferably 200 cpm or more. The AC smoke exerts strong repellent effect for rodents even in a small amount.

In the rodent repelling method (4) of the invention, those which generate smoke by thermally decomposing at around 200° C. are desirable as the azodicarbonamide, and in addition to azodicarbonamide, those which have smells and are vaporized at room temperature among azobisisobutyronitrile, azo pigments and the like azo compounds and the like can be cited.

According to rodent repelling method (4) of the invention, the smoke quantity is not particularly limited with the proviso that it is an amount sufficient for disturbing movement of rodents and getting rid of the warning nature of rodents, and for example, it is desirable to diffuse it into a space such that a smoke quantity inside the space becomes 45 cpm or more, preferably 100 cpm or more, more preferably 200 cpm or more. The smoke exerts strong repellent effect for rodents and is apt to disturb movement of rodents even in a small amount.

The aforementioned vaporization ingredient may be contained in the smoke.

According to the rodent repelling method (4) of the invention, those which generate smoke by thermally decomposing at around 200° C. are desirable as the gas generating agent azodicarbonamide (to be referred sometimes to as AC smoke hereinafter), and Unifoam AZ (manufactured by Otsuka Chemical Co., Ltd.), SELLMIC CE (manufactured by SANKYO Chemical Co., Ltd.) and the like can be exemplified.

According to the rodent repelling method (4) of the invention, thermal decomposition of azodicarbonamide can be carried out, for example, by putting azodicarbonamide in the container of the smoke generating device shown in FIG. 1 and heating it by a heating means arranged on the outside of said container.

According to the rodent repelling methods (3) and (4) of the invention, it is desirable to arrange a rodent repellent after vaporizing a vaporization ingredient or generating smoke by a smoke generator.

In this connection, the vaporization or generation of smoke may be repeated twice or more. By the learning effect of rodents, unpleasant memory of the repellent ingredient continues over a long period of time so that the effect of the rodent repellent also continues over a long period of time as a result.

In addition, it is also desirable to arrange the rodent repellent and continue vaporization or generation of smoke at intervals of several weeks to several months.

### (Arrangement of Rodent Repellent)

According to the rodent repelling methods (3) and (4) of the invention, a rodent repellent containing at least one species of the aforementioned rodent repellent ingredients is arranged within the aforementioned space. Though the rodent repellent is not particularly limited, it is necessary that it contains at least one species of the rodent repellent ingredients in the smoke used in the smoke generation. According to the rodent repelling methods (3) and (4) of the invention, it is desirable that this is completely identical to the aforementioned rodent repellent ingredient in the vaporization ingredient or smoke. According to this, since the rodents having high learning effect memorize the repellent effect of the smoke, they extremely unpleasantly feel the rodent repellent containing the same repellent ingredient of the vaporization ingredient or smoke, so that effect of the rodent repellent is sharply increased and the repellent effect is continued.

As the rodent repellent to be used in the invention, those which gradually vaporize the repellent ingredient are preferable, and as illustrative examples, a gel product and the like which can effect improvement of vaporizing ability of the repellent, improvement of the persistency of vaporization and maintenance of the shape keeping ability of gel can be suitably used.

According to the rodent repelling methods (3) and (4) of the invention, it is desirable to use rosemary oil in the rodent repellent as an active ingredient. As the available rosemary oil, for example, rosemary cineol, rosemary verbenone, rosemary camphor and the like can be cited.

Also, in addition to the rosemary oil, at least one of p-cymene, γ-terpinene, hexyl acetate, terpineol and orange oil can be blended. When these secondary components are jointly used, the rosemary oil is preferably 20% by mass or more, more preferably 30% by mass or more, based on the total amount of the active ingredient.

In addition, it is possible to blend other components as occasion demands and, for example, an appropriate amount of a coloring agent, an ultraviolet ray absorbent, an antiseptic, an antioxidant and the like may be blended.

As the preparation examples of rodent repellent, for example, fumigants, gels, propellants, powders, granular formulation, granules, solutions, sheets and the like can be cited. In this connection, blending amount and using amount of the rosemary oil and secondary components are selected in such a manner that they become the effective amounts suited for these preparations.

According to the invention, it is desirable to use a gel product as the rodent repellent.

The gel product is constituted from a container, a cap and a gel which contains a volatile agent, and it is desirable that the cap is attached to the container packed with a gel.

The gel can be produced to a gel strength of 100 gf/cm² or more by heating and uniformly mixing the aforementioned rodent repellent ingredient, a gelling agent (e.g., agar, carrageenan, geran gum, xanthan gum or the like), a solvent (e.g., water, an alcohol, a polyhydric alcohol or the like) and the like, followed by filling in the container and subsequent solidification with cooling. In addition, as occasion demands, surfactants (e.g., various surfactants of POE(polyoxyethylene).POP(polyoxypropylene) block copolymer, POE hydrogenated castor oil, POE alkyl ether, SG-3 (trade name; manufactured by Matsumoto Yushi) or the like nonionic system, aliphatic carboxylate, dialkyl sulfate, alkyl phosphate or the like anionic system, alkyl amine salt, quaternary ammonium salt or the like cationic system, alkyl betaine or the like ampholytic system, amine acid system and the like), antiseptics (e.g., paraben, BIOSAIDO (trade name) and the like), antioxidants (e.g., BHT, BHA, polyphenol, vitamin and the like), coloring agents (e.g., yellow, blue, red, green, purple, orange and the like), ultraviolet ray absorbents, antifoaming agents and the like may be blended.

The place where the aforementioned rodent repellent is used is optional, but it is desirable that it is an air convection region inside a space where rodents are present and/or a dark area inside the aforementioned space. In this connection, as examples of the air convection region, an inspection opening, a ventilation opening, piping and the like arranged inside the space can be cited, and the air from the outside of the aforementioned space is generally run in through these. In addition, the dark area inside the aforementioned space means a place in the space where a light is relatively poor.

As the rodent which becomes the evasive object in the invention, for example, a brown rat, a water rat, a house mouse, a mouse, a rat and the like can be cited.

Next, the method for capturing a rodent in which a vaporization ingredient is vaporized within a space where a rodent is present and the rodent is captured by a rodent trap arranged within the aforementioned space (to be referred to as rodent capturing method (5) hereinafter) and the method for capturing a rodent in which smoke is generated by a smoke generator within a space where a rodent is present and the rodent is captured by a rodent trap arranged within the aforementioned space (to be referred to as rodent capturing method (6) hereinafter) are described.

### (Vaporization Ingredient)

As the vaporization ingredient to be used in the rodent capturing method (5) of the invention, it is not particularly limited with the proviso that it is vaporized in the air and thereby can get rid of the warning nature of rodents by disturbing movement of rodents, but it is desirable to be vaporized by a vaporization device.

Though the vaporization ingredient to be used in the rodent capturing method (5) of the invention is not particularly limited, for example, metoxadiazone, pyrazolone orange, azobenzene and the like can be cited.

As the vaporization device in the rodent capturing method (5) of the invention, those which can vaporize a vaporization ingredient at room temperature or under heating are desirable, and for example, the vaporization device described in JP-A-11-127754 can be used. According to the invention, it is desirable to heat the vaporization ingredient on a board heated, for example, to 200° C. to 500° C.

### (Generation of Smoke)

According to the rodent capturing method (6) of the invention, it is desirable to generate smoke by a smoke generator within a space where a rodent is present. Though the smoke generator to be used in the invention is not particularly limited, for example, a device which uses a smoking agent, a device which uses a fumigant, a smoke candle and the like can be cited, and a fire cracker and the like which generate smoke and sound can also be used.

Such devices can be used by putting them on a habitat or activity area of rodents or, in the case of an attic, under the floor and the like narrow spaces, by supplying the smoke generated at a separate place through a pipe or the like.

According to the rodent capturing method (6) of the invention, it is particularly desirable that a smoke generated by thermal decomposition of a gas-generating agent is generated by the smoke generator within the space where rodents are present.

As the gas-generating agent, azodicarbonamide, benzoyl peroxide, nitrocellulose, picric acid, trinitrotoluene, dinitrosopentamethylenetetramine, azobisisobutyronitrile, diazonitrophenol, hydrazine sulfate, sodium azide, guanidine nitrate and the like can be cited. According to the invention, it is desirable to use azodicarbonamide.

The smoke quantity is not particularly limited with the proviso that it is an amount sufficient for disturbing movement of rodents and getting rid of the warning nature of rodents, and for example, it is desirable to diffuse it into a space such that it becomes 45 cpm or more, preferably 100 cpm or more, more preferably 200 cpm or more inside the space. The smoke exerts strong repellent effect for rodents and is apt to disturb movement of rodents even in a small amount.

The aforementioned vaporization ingredient may be contained in the smoke.

According to the rodent capturing methods (5) and (6) of the invention, those which generate smoke by thermally decomposing at around 200° C. are desirable asl the gas generating agent azodicarbonamide, and Unifoam AZ (manufactured by Otsuka Chemical Co., Ltd.), SELLMIC CE (manufactured by SANKYO Chemical Co., Ltd.) and the like can be exemplified.

According to the rodent capturing methods (5) and 6) of the invention, thermal decomposition of the gas-generating agent (azodicarbonamide) can be carried out, for example, by putting azodicarbonamide in the container of the smoke generating device shown in FIG. 1 and heating it by a heating means arranged on the outside of said container.

Though the rodent capturing methods (5) and (6) of the invention can sufficiently exert the rodent repellent effect without using a repellent ingredient in the AC smoke, various components having rodent repellent effect, or rodent repellent ingredients, may be contained in the smoke as occasion demands. As the rodent repellent ingredients, for example, a Japanese horseradish component (allyl isothiocyanate), shellflower extract, monoterpenes, essential oil components such as peppermint oil, rosemary oil, lemongrass oil, lavender oil, orange oil and the like can be cited.

### (Rodent Trap)

The rodent trap to be used in the rodent capturing methods (5) and (6) of the invention is not particularly limited, but those of plate or tunnel shape adhesion type or wire netting type can be exemplified, of which a plate shape adhesion type trap is desirable.

As such a plate shape adhesion type rodent trap, those in which an adhesive is coated on a plate shape sheet substrate can be exemplified.

As the sheet substrate, for example, it can be formed by a film-shaped member formed from polyethylene, polypropylene, polyethylene terephthalate or the like, a cardboard, a corrugated board, a plastic plate, a metal plate or the like alone or a combination thereof, and a plate-shaped member formed from a plate having a certain degree of flexibility and weight can also be used. As occasion demands, for example, deposition processing of an aluminum or the like metal or application processing of aluminum foil or the like metal foil, a plastic sheet or the like may be carried out. The sheet substrate may be a square form instead of a rectangle form. In addition, it is desirable to use the sheet substrate by setting up on a floor and it is desirable to color it with the same line of color.

An adhesive layer is formed on the surface of the sheet substrate by applying an adhesive. As the adhesive for forming this adhesive layer, rubbers or synthetic resins are used as the main component and large amounts of a softener, a tackifier and the like are added thereto. As the softener, light process oil, mineral oil, animal or plant oil, low molecular weight polyethylene and polyisobutylene, polybutene and the like can be exemplified. As the tackifier, a rosin system resin, a terpene system resin and the like can be exemplified. As occasion demands, for example, the adhesive may contain a medical agent such as a rodent poison or the like. In addition, in order to prevent accidental adhesion of a dog, cat and the like pets to the adhesive layer, a repellent for these pets may be added to the adhesive layer. As the repellent, a repellent which contains methyl nonyl ketone derivative as an active ingredient [e.g., REPULSIF D' INTERIEUR, the content 3.17% by weight, manufactured by CANY'S (France)] and the like can be exemplified, but not limited thereto, and it may be any substance which has the repellent effect for a dog, cat or the like pet and does not have, or is inferior in, the repellent effect for the small animals to be captured. In this connection, the adhesive layer is applied to the entire face of the sheet substrate, but it may be a zigzag application or a partial application. In addition, the rodent traps described in JP-A-2003-289786, JP-A-2003-189780, JP-A-2007-104918 and the like can be used suitably.

Though the place for setting up the aforementioned rodent trap is optional, it is desirably an air convection region inside a space where rodents are present and/or a dark area inside the aforementioned space. According to an examination by the present inventors, it was revealed that rodents have positive taxis against air convection and have negative taxis against light. Accordingly, when a rodent trap is set up in an air convection region inside a space where rodents are present and/or a dark area inside the aforementioned space, the rodents which lost their warning nature caused by the smoke from the smoke generator are apt to behave in response to their instinct so that the effect to capture rodents is further improved. In this connection, an inspection opening, a ventilation opening, piping and the like can be exemplified as the air convection region arranged inside the space, and the air from the outside of the aforementioned space is generally run in through these. In addition, the dark area inside the aforementioned space means a place in the space where a light is relatively poor.

According to the rodent capturing methods (5) and (6) of the invention, a brown rat, a water rat, a house mouse, a mouse, a rat and the like can for example be cited as the rodent to be captured. When a smoke is introduced into a space where these rodents are present in an amount sufficient enough for disturbing behavior of the rodents, the rodents rested until that time lose sight of the generally used entrance, start circling movement and fall into a panic. By disturbing movement of rodents and thereby getting rid of warning nature of rodents, they are easily captured in the rodent trap.

### (Kit for Rodent Trap)

The kit for rodent trap of the invention comprises the aforementioned vaporization device or smoke generator and rodent trap. According to the kit for rodent trap of the invention, rodents can be efficiently captured.

### BEST MODE FOR CARRYING OUT THE INVENTION

A smoke generator 1 shown in the drawings is equipped with a bottomed cylindrical outer container 2, and a hydroexothermic substance A is contained therein through the bottom to side. In addition, inside of the outer container 2 is divided into two spaces by a partition member 4. The outer container 2 has two or more water passing holes on its bottom, and the water passing holes are stopped up with a member having water-passing property, such as a non-woven fabric sheet 3. When used, water W flows into the outer container 2 through the water passing holes by putting a self heat generator 1 into a container 20 charged with the water W, and then contacts with the hydroexothermic substance A by permeating through the non-woven fabric sheet 3, and the azodicarbonamide B is heated and hydrolyzed by the thereby generated heat of reaction and the thus generated smoke is released into the outside moiety (the interior of a room or the like) through the ventilation hole of a hot melt film 7 and the opening of a cover member 6.

Such a device can be used by putting it on a habitat or activity area of rodents or, in the case of an attic, under the floor and the like narrow spaces, by supplying the smoke generated at a separate place through a pipe or the like.

### EXAMPLES

The following describes the invention further in detail based on examples, but the invention is not limited thereto.

### Test Example 1

Rodent repellent effect was confirmed as follows using the test device shown in FIG. 2.

A vat (1 m in length, 1.5 m in breadth and 1 m in height) was set up in a room A (3 m in length, 4.5 m in breadth and 2.5 m in height). Next, a cage (40 cm in length, 25 cm in breadth and 20 cm in height) was set up in a room B (3 m in length, 4.5 m in breadth and 2.5 m in height). Thereafter, the vat and cage were connected with a pipe (7.5 cm in diameter and 50 cm in length) by passing through the wall to render possible free movement of rodents.

In addition, the room A was darkened and the cage in the room B was lighted with an illumination of 300 W (such conditions that rodents generally do not break into the room B, since rats detest light). Subsequently, 5 animals of a rodent (mouse) were released in the room A and the room B side was observed.

By generating smoke from the test samples described in Table 1, the number of rodents broken into the room B over 30 minutes was counted as the number of repelled rodents, and their staying period of time at that time was observed.

In addition, regarding rodents which were broken into the room B and returned to the room A, when they again moved to the room B, their number was counted in a similar manner.

Regarding the test samples, in Examples 1 to 3, azodicarbonamide in the respective amount (dosage) described in Table 1 was contained in the inner container of the double layer container, 65 g of calcium oxide was contained in the outer container in such a manner that it is positioned in the outside of said container, and smoke was generated by the thermal decomposition of azodicarbonamide through its heating by adding water and thereby generating heat of about 300° C.

In Comparative Example 1, a commercially available smoking agent, nitrocellulose, was contained in the container in the amount (dosage) described in Table 1 and smoke was generated by igniting it.

In the control, azodicarbonamide was not contained in the container of Examples, and heating was carried out under the empty condition using calcium oxide by the same method of Example 1.

Results of the test are shown in Table 1.

Total value of repelled rodents is increased accompanied by the increase of dosage in Examples 1 to 3 which used azodicarbonamide. In addition, a distinct difference was observed in comparison with the control even by its used amount of 0.2 g. There was no significant difference in comparison with the control when nitrocellulose as the Comparative Example was used.

TABLE 1
Test results

| | | The number of invasion into room B and staying | | | | |
|---|---|---|---|---|---|---|
| | | time at that time in the room B | | | | |
| | | Less | | | 3 min | |
| | | than | | | or | Total of |
| Test sample | Dosage | 1 min | 1 to 2 min | 2 to 3 min | more | repellent |
| Example 1 | 0.2 g | 8 | 3 | 3 | 1 | 15 |
| Example 2 | 1 g | 14 | 4 | 2 | 1 | 21 |
| Example 3 | 10 g | 10 | 6 | 2 | 5 | 23 |
| Comparative | 23 g | 2 | 2 | 2 | 1 | 7 |
| Ex. 1 | | | | | | |
| Control | — | 2 | 1 | 1 | 0 | 4 |

### Test Example 2

Smoke quantities of Examples 1 and 2 and Comparative Example 1, and Control used in Test Example 1 were measured using Digital Dust Indicator Model P-3 (manufactured by SHIBATA KAGAKU).

Regarding the measurement of smoke quantity, each sample was put on the floor of the room A of Test Example 1 to generate smoke, and smoke quantities were measured for 30 minutes at 5 minute intervals after generation of smoke and their average value was calculated.

As a result of the measurement, even the control yielded about 309 cpm as average dust quantity by heating of the container. Accordingly, average dust quantities of Examples 1 and 2 and Comparative Example 1 were corrected by subtracting the value of the control, the corrected values are described in Table 2.

Results of the test are shown in Table 2. When azodicarbonamide was used, the smoke quantities were almost proportional to the used amounts. The smoke quantity in the case of the Comparative Example which used nitrocellulose was about 7 times than the case of the use of azodicarbonamide.

From this result, it can be seen that not a larger smoke quantity is the best but the smoke generated by the thermal decomposition of azodicarbonamide is effective for the repellent of rodents with a smaller smoke quantity than that of the Comparative Example.

TABLE 2
Test results

| Samples | Average dust quantity |
|---|---|
| Example 1 | 46.4 cpm |
| Example 2 | 227.8 cpm |
| Comparative Example 1 | 1823.1 cpm |

### Test Example 3

Test samples were produced by blending Example 3 with 10% peppermint oil (Example 4), 10% peppermint oil and 2% essential oils (Example 5) or 8% peppermint oil and 4% essential oils (Example 6), and rodent repellent effect was verified by carrying out the test in the same manner as in Test Example 1.

The essential oils are oil containing 40% rosemary oil, 10% terpineol, 10% terpinene, 10% p-cymene and 5% hexyl acetate.

The peppermint oil is oil containing 40% 1-menthol and 20% menthyl acetate.

Results of the test are shown in Table 3. The difference in the repellent effect was not found in the case of the blending with peppermint oil (Example 4) and in the case of the blending with peppermint oil and 2% essential oils (Example 5). Distinct improvement of the repellent effect was found when added amount of the essential oils was increased (Example 6).

TABLE 3
Test results

| | The number of invasion into room B | | | | |
|---|---|---|---|---|---|
| | and staying time at that time | | | | |
| | Less than | | | 3 min or | Total of |
| Test sample | 1 min | 1 to 2 min | 2 to 3 min | more | repellent |
| Example 4 | 14 | 5 | 5 | 1 | 25 |
| Example 5 | 17 | 7 | 1 | 4 | 29 |
| Example 6 | 20 | 7 | 2 | 6 | 35 |

### Example 7

An attempt was made to capture brown rat broken into the attic of a food factory office having an area of 150 square meters (10 m×15 m). As a result of using one per 25 square meters, a total of 6, of a repellent (contains peppermint oil and rosemary oil as the repellent ingredients) equipped with the smoke generator shown in FIG. 1, the presence of rodents was not observed from the next day. Thereafter, the presence of rodents was not observed for 2 months, but rodents started to invade and act violently after 2 months. Accordingly, when the same smoking type repellent was used and, at the same time, a gel type repellent which used peppermint oil and rosemary oil as the repellent ingredient was set up 8 positions in the attic, re-invasion of the rodents was not observed even after the passage of 6 months.

### Test Example 4

Using the test device shown in FIG. 3, taxis of rodents against air convection was verified.

A vat 11 (1 m in length, 1.5 m in breadth and 1 m in height) was set up in a room A (3 m in length, 4.5 m in breadth and 2.5 m in height). Next, two cages 21 and (respectively 40 cm in length, 25 cm in breadth and 20 cm in height) were set up in a room B (3 m in length, 4.5 m in breadth and 2.5 m in height). Thereafter, the vat 11 and cages 21 and 22 were connected with pipes 101 and 102 (7.5 cm in diameter and 50 cm in length) by passing through the wall to render possible free movement of rodents. The room A and room B are darkrooms.

In this connection, the vicinity of pipe 102 was set up as the air convection region by arranging a fan 1021 inside of one pipe 102 and revolving the fan to a wind speed of 1.05 m/s. In this connection, the vicinity of pipe 101 is a dead calm and convection of air is not found.

Next, using the smoke generator 10 shown in FIG. 3, 10 g of granules the following repellent A was smoked. The smoke was introduced into the room A to a level of 1,000 cpm, and 10 animals of mouse were released to the vat 11 in the room A. In this connection, a partition was arranged between both rooms so that the mice cannot move between the room A and room B for 2 minutes under this condition. After the passage of 2 minutes, the partition was opened and movement of the mice was observed for 1 minute thereafter. As a result, 9 animals of mouse entered into the cage 22 through the pipe 102, thus confirming that mouse has positive taxis against air convection. In this connection, even 1 animal of mouse did not enter into the cage 21.

Based on this, it was suggested that capturing effect of rodents is improved by setting up a rodent trap in an air convection region.

### Repellent A:

| | |
|---|---|
| Peppermint oil | 0.8 g |
| Rosemary oil | 0.4 g |
| Alfa starch (Amycol H: manufactured by NIPPON | 0.2 g |
| STARCH CHEMICAL) | |
| Azodicarbonamide (Unifoam AZ: manufactured by | 8.6 g |
| Otsuka Chemical Co., Ltd.) | |

### Test Example 5

Taxis of rodents against air convection was verified. The test device was the same as in the aforementioned Test Example 1 except that, in FIG. 3, the room B was used as a light room by fluorescent light irradiation and the cage 21 and pipe 101 were made into a dark room state by shading. According to this, light enters into the room A from the cage 22 and pipe 102, and the vicinity of the pipe 101 was relatively set up as the dark region. In this connection, the fan 1021 is not working.

Next, in the same manner as in Test Example 1, 10 g of granules the repellent A was smoked using the smoke generator 10 shown in FIG. 3. The smoke was introduced into the room A to a level of 1,000 cpm, and 10 animals of mouse were released to the vat 11 in the room A. In this connection, a partition was arranged between both rooms so that the mice cannot move between the room A and room B for 2 minutes under this condition. After the passage of 2 minutes, the partition was opened and movement of the mice was observed for 1 minute thereafter. As a result, 4 animals of mouse entered into the cage 21 of a dark room state through the pipe 101, thus confirming that mouse has negative taxis against light (2 animals of the aforementioned 4 animals of mouse once peeped into the cage 22 of light room state but seemed to be challenged by seeing light, so that finally entered into the cage 21 of dark room state). In this connection, even 1 animal of mouse did not enter into the cage 22 of light room state.

Based on this, it was suggested that capturing effect of rodents is improved by setting up a rodent trap in a dark region.

### Example 8

An attempt was made to capture brown rat broken into the attic of a food factory office having an area of 150 square meters (10 m×15 m).

One per 25 square meters, a total of 6, of a repellent (contains peppermint oil and rosemary oil as the repellent ingredients) equipped with the smoke generator shown in FIG. 1 was used, and 25 sheets for each, a total of 100 sheets, of an adhesive sheet 310 were arranged around 4 inspection holes 301, 302, 303 and 304 where fresh air always goes in and out. As a result of recovering the adhesive sheet after 2 hours of operation of the smoking type repellent, it was able to capture a total of 6 animals of the brown rat.

### Comparative Example 2

An attempt was made to capture brown rat broken into the attic of a food factory office having an area of 150 square meters (10 m×15 m). An attempt was made to capture by spreading 1,000 sheets of an adhesive sheet all over the area, but even one animal was not able to capture.

### Test Example 6

A total of 16 animals of a mouse (ddY male mouse of 7 weeks of age) were released in a rearing cage (16 cm in breadth, 23 cm in length and 20 cm in height). Thereafter, a piece of filter paper (1 cm in width and 10 cm in length) impregnated with 50 μl of essential oil shown in the following Table 4 or 50 μl of water was hung down from the center of the ceiling of the rearing cage, and a period of time until a state in which mice gathered in the periphery in the rearing cage but mice are not present around the filter paper (inhibition zone) is formed was measured. The results are shown in Table 4.

TABLE 4

| | | | Formation rate of |
|---|---|---|---|
| | | Presence of | inhibition zone |
| | | inhibition zone | (sec) |
| Essential oil | Rosemary oil | present | 8 |
| tested | p-Cymene | present | 50 |
| | γ-Terpinene | present | 23 |
| | Hexyl acetate | present | 24 |
| | Terpineol | present | 56 |
| | Orange oil | present | 25 |
| Comparative | Water | absent | — |
| plot | | | |

From Table 4, it can be understood that since the inhibition zone is formed within most short time by the use of rosemary oil, it is excellent in the repellent effect for mice in comparison with other essential oils.

### Test Example 7

A test was carried out using the repellent tester shown in FIG. 5. As shown in the drawing, a cage A arranged in a dark room and a cage B arranged in a light room lighted up with an illumination of 300 W were connected with a passage. Also, a drug preparation was prepared by allowing 2 g of a hold-back carrier containing Flolite and azodicarbonamide (AZ) to absorb 1 g of the essential oil composition shown in the following Table 5, and filling it in a heating can. Thereafter, the dark room (cage A side) was fumigated with the drug preparation, 5 animals of mouse were released in the cage A and then the period of time wherein the mice which shifted to the cage B stayed in the cage B was measured for 30 minutes. Also, for the sake of comparison, mice were observed without carrying out fumigation of the drug preparation. The results are shown in the following Table 6. Since mice have a liking for a dark room, the shifting to the cage B can be regarded as a repellent effect by the essential oil composition. In this connection, staying time of the mice which returned to the cage A after shifting to the cage B and then shifted again to the cage B was also measured.

TABLE 5

| | Essential oil-containing | Composition |
|---|---|---|
| | composition | (% by mass) |
| Essential oil and the | Rosemary oil | 40 |
| like | p-Cymene | 10 |
| | γ-Terpinene | 10 |
| | Hexyl acetate | 5 |
| | Terpineol | 10 |
| | Orange oil | 5 |
| Solvent | Propylene glycol | 20 |

TABLE 6
(mouse)

| | Frequency of shifting and room B staying time | | | | |
|---|---|---|---|---|---|
| | | | | 3 min or | |
| Conditions | Less than 1 min | 1 to 2 min | 2 to 3 min | more | Total |
| Drug plot | 10 | 9 | 3 | 8 | 30 |
| Untreated | 0 | 0 | 0 | 0 | 0 |
| plot | | | | | |

Repellent effect of the rodent repellent of the invention was confirmed also from Table 6.

### Test Example 8

Repellent effect for brown rat was tested in the same manner as in the Test Example 7, except that 3 animals of brown rat were used instead of mouse.

TABLE 7
(brown rat)

| | Frequency of shifting and room B staying time | | | | |
|---|---|---|---|---|---|
| | | | | 3 min or | |
| Conditions | Less than 1 min | 1 to 2 min | 2 to 3 min | more | Total |
| Drug plot | 13 | 1 | 0 | 1 | 15 |
| Untreated | 0 | 0 | 0 | 0 | 0 |
| plot | | | | | |

Repellent effect of the rodent repellent of the invention was confirmed also from Table 7.

### Test Example 9

A rosemary oil-containing gel preparation was prepared by the formulation shown in the following Table 8. Also, as was carried out in Test Example 7, a cage A arranged in a dark room and a cage B arranged in a light room were connected through a passage, and water and feed were arranged in the cage A and 5 animals of mouse were released therein. Thereafter, the prepared gel preparation was arranged in the cage A and the number of mice shifted to the cage B was counted for 20 minutes. In addition, for the sake of comparison, mice were observed without arranging the gel preparation. The results are shown in Table 9.

TABLE 8

| | Composition |
|---|---|
| Components | (% by mass) |
| Peppermint oil | 3.5 |
| Essential oil composition of Table 5 | 0.5 |
| Cat odor perfume | 0.01 |
| Natural Japanese horseradish oil | 0.01 |
| Gelling agent | 1.1 |
| (Trade name: Sun Fresh 500D) | |
| Antiseptic (phenoxyethanol) | 0.2 |
| Purified water | Balance for adjusting |
| | 100% in total |

TABLE 9

| | The number of shifted mice | | | | | | | | | |
|---|---|---|---|---|---|---|---|---|---|---|
| | | | | | | 10 to | 12 to | 14 to | 16 to | |
| Conditions | 0 to 2 min | 2 to 4 min | 4 to 6 min | 6 to 8 min | 8 to 10 min | 12 min | 14 min | 16 min | 18 min | 18 to 20 min |
| Drug plot | 5 | 5 | 6 | 6 | 4 | 5 | 4 | 4 | 7 | 6 |
| Untreated | 0 | 1 | 0 | 1 | 1 | 0 | 0 | 1 | 0 | 1 |
| plot | | | | | | | | | | |

Repellent effect of the rodent repellent of the invention was confirmed also from Table 9.

While the invention has been described in detail and with reference to specific embodiments thereof, it will be apparent to one skilled in the art that various changes and modifications can be made therein without departing from the scope thereof.

This application is based on Japanese patent application No. 2006-351454 filed on Dec. 27, 2006, Japanese patent application No. 2006-355015 filed on Dec. 28, 2006, Japanese patent application No. 2007-186738 filed on Jul. 18, 2007, Japanese patent application No. 2007-188280 filed on Jul. 19, 2007, the entire contents thereof being hereby incorporated by reference.

### BRIEF DESCRIPTION OF THE DRAWINGS

FIG. 1 is a sectional view showing an embodiment of the device which generates smoke by thermally decomposing azodicarbonamide.

FIG. 2 is a schematic illustration showing the device of the invention used in Test Example 1.

FIG. 3 is a schematic illustration showing the device of the invention used in Test Example 4.

FIG. 4 is a plan view showing the attic in Example 8.

FIG. 5 is an illustration for describing the test methods of Test Example 7 and Test Example B.

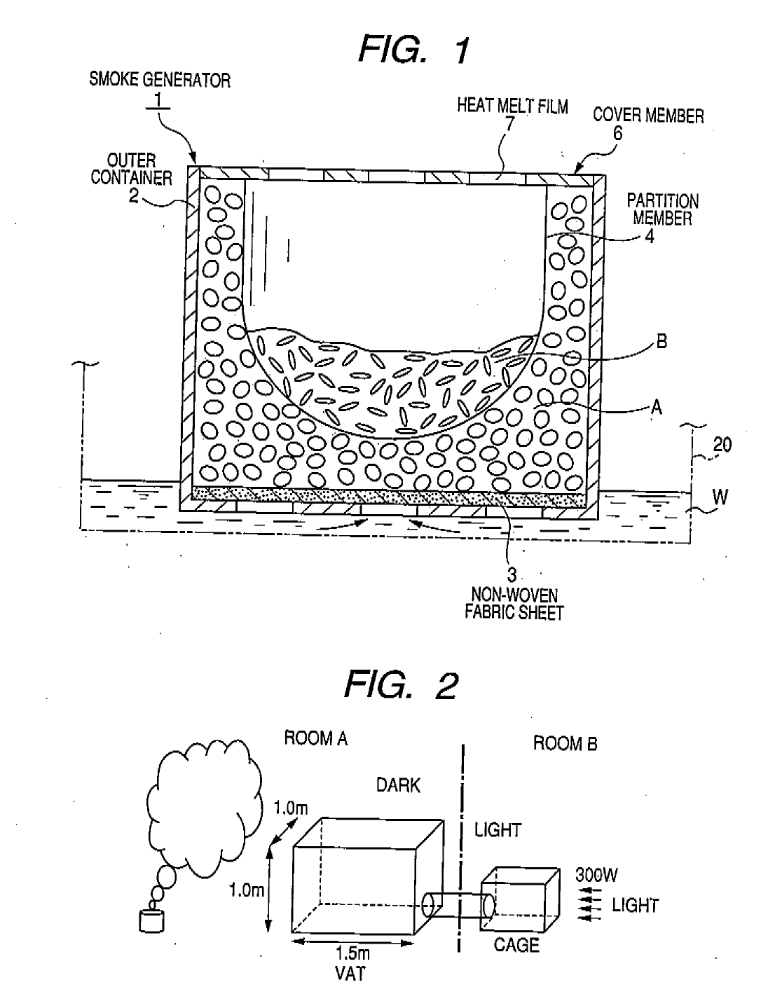

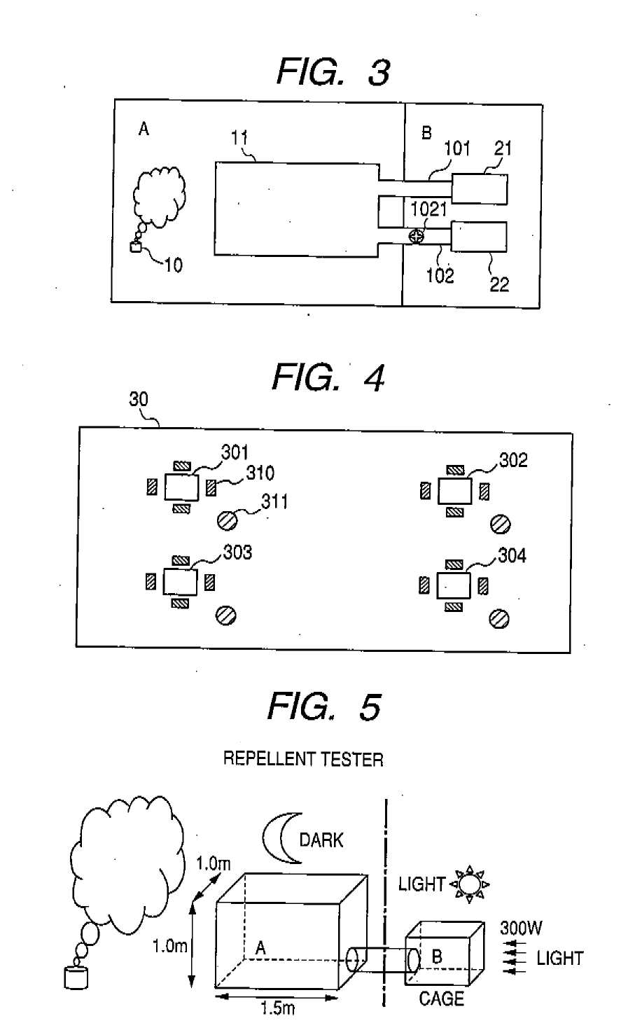

### DESCRIPTION OF THE REFERENCE NUMERALS AND SIGNS

1 Smoke generator
2 Outer container
3 Non-woven fabric sheet
4 Partition member
6 Cover member
7 Heat melt film
20 Container
A Hydroexothermic substance
B Azodicarbonamide
W Water
11 Vat
21, 22 Cage
101, 102 Pipe
1021 Fan
30 Attic
301, 302, 303, 304 Inspection hole
310 Adhesive sheet
311 Smoke generator

1. A method for repelling a rodent, which comprises a step of using a smoke generated by thermal decomposition of azodicarbonamide as an active ingredient and diffusing the aforementioned smoke to a smoke quantity of 45 cpm or more, or vaporizing a vaporization ingredient within a space where the rodent is present.

2. The method for repelling a rodent according to claim 1, wherein a smoke generated by thermal decomposition of azodicarbonamide is used as the active ingredient and the aforementioned smoke is diffused to a smoke quantity of 45 cpm or more and essential oils are also used as a rodent repellent.

3. A method for repelling a rodent, which comprises vaporizing a vaporization ingredient within a space where a rodent is present and using a rodent repellent containing at least one species of the rodent repellent ingredients within the aforementioned space.

4. A method for repelling a rodent, which comprises generating smoke by a smoke generator within a space where a rodent is present and using a rodent repellent containing at least one species of the rodent repellent ingredients within the aforementioned space.

5. A method for capturing a rodent, which comprises vaporizing a vaporization ingredient within a space where a rodent is present and capturing the rodent by a rodent trap arranged within the aforementioned space.

6. A method for capturing a rodent, which comprises generating smoke by a smoke generator within a space where a rodent is present and capturing the rodent by a rodent trap arranged within the aforementioned space.

7. A rodent repellent for use in the method for repelling a rodent described in claim 3 or 4, which comprises rosemary oil as an active ingredient.
